(19) United States
(12) Patent Application Publication
(10) Pub. No.: US 2022/0366785 A1
(43) Pub. Date: Nov. 17, 2022

(54) Traffic Signal Linear Mixed Green-Wave Mode Control Method

(71) Applicant: Weiping Meng, Flushing, NY (US)

(72) Inventor: Weiping Meng, Flushing, NY (US)

(21) Appl. No.: 17/760,757

(22) PCT Filed: Nov. 20, 2019
(86) PCT No.: PCT/CN2019/000224

§ 371 Date: Mar. 15, 2022

(30) Foreign Application Priority Data
Sep. 17, 2019 (CN) 201910873289.0

(51) Int. Cl. G08G 1/083

(52) U.S. Cl. CPC G08G 1/083

(57) ABSTRACT

The invention is a traffic signal green wave mode control method for polylines and mixture mode of Lead and Jam-Relief functions, includes: 1) get parameters of polylines and mixture mode according to mode instruction, compute time-offsets of each wave section starting from source intersection; 2) connecting the time-offsets between wave sections, 3) set interim period using the wave sections' time-offsets; provides for polylines route traffic signal connecting channel, linking functions Lead and Jam-Relief within multi wave sections, multi road-segments, multi turnings of vehicle flow; comparing to current non-the-polylines-mixture-mode traffic signal modes, waiting time is lessened by far more than 50%, efficiency of transportation is improved greatly.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates to a traffic control method, particularly to traffic signal polylines green wave method for Lead and Jam-Relief.

Currently traffic signal Lead and Jam-Relief green-wave modes solve no-stop pass traffic between intersections' straight phases, increase vehicle mobility. In reality, there are quite much amount of Lead demand in Jam-Relief traffic, and polylines traffic demands, needing related high efficient signal modes to handle. If polyline jam traffic can be controlled by related polylines traffic signal green-wave with mixture of Lead and Jam-Relief mode, the demand of turning traffic can be handled high efficiently, and traffic wait-time will be decreased.

### BRIEF SUMMARY OF THE INVENTION

It is an object of the present invention to realize the polylines Lead and Jam-Relief mixture green-wave mode, decrease turning-traffic wait-time, improve the efficiency of traffic.

The present invention, with help of new signals' technologies including real-time moding, Jam-Relief, and out-phase, achieve the above object.

A method for polylines Lead and Jam-Relief mixture mode in traffic signal network includes steps:

S1, Set RATIO as initial state with obtaining length and traffic time of every road-segment of a road-net;

S2, Set polylines mixture wave mode according to mode instruction: 1) get parameters of polylines mixture wave of the mode instruction; 2) set a signal interim period of the polylines mixture wave: start polylines mixture wave, or, end;

S3, Run the new mode after running out the respective interim period of every intersection;

Said road-net is a group of mutually crossing roads, wherein its crossing points with their every directions controlled with traffic signals, called as intersections, divide the roads into road-segments, parallelly topologically;

Said RATIO is a traffic signal mode of road-nets, wherein all intersections' traffic signals run on ratio-rule synchronously, said ratio-rule bases on a period and ratios dividing the period into traffic signals controlling directions, said period is traffic signal green light times' sum of every directions controlled of an intersection;

Said polylines mixture wave means traffic signal phase green lights of road-segments connected include not only mixture of straight phase wave and out-phase wave of left-turn phase and right-turn phase but also mixture of functions of Jam-Relief and Lead; Said out-phase wave means traffic signal phase green lights connected between intersections include turning phases of left-turn phase and right-turn phase, is an out-phase mode of green-wave; Said green-wave ordinarily means that traffic signal green lights' phases connected between intersections only are straight phase based on said ratio-rule and time-offsets, runs on said ratio-rule asynchronously, and orderly time-offsets make green light signal propagate between intersections directionally, from a source intersection to the intersection's adjacent one with bigger time-offset; Said source-intersection is an intersection of a green-wave set smallest time-offset comparing with the other intersections in the green-wave road-net;

Said interim period is sum of traffic signal green light interim times in all directions controlled, is period remainder of switch time-offset of new mode comparing with current mode, in which traffic signal mode of an intersection changes from current mode to new mode; Said switch-time-offset is time-offset of two modes of new mode comparing with current mode, equals sum of current mode's complement and new mode's remainder; Said remainder is period remainder, =remainder (time-offset/period); Said complement is period complement, =period−remainder; Said time-off is a delay of an intersection period comparing with a mode source intersection period, related to cared distance and traffic time, is sum of all related road-segments time-offsets from source intersection to a downstream intersection of a green-wave;

Said traffic-time includes set-drive-time or JVQ-start-time; said set-drive-time equals to time that a vehicle drives at set-drive-speed through a whole road-segment; said JVQ means jammed vehicle queue, its length as a parameter of Jam-Relief green-wave is the length of a road-segment it is in; said JVQ-start-time is a basic parameter of Ram-Relief green-wave, means time from when the first vehicle of JVQ start to move to when last vehicle of JVQ start to move, equals to JVQ-start-coefficient*jam-coefficient*road-segment-length; said JVQ-start-coefficient are empirical values of JVQ start, in range of 0.10 to 0.26, taking middle value 0.18 usually, unit: second/meter, also may be obtained from certain functions or statistical principle dynamically; said jam-coefficient is less than or equal to one, “equals to one” means that heavy jam occurs;

Said parameters of polylines mixture wave include first-intersection and its direction and phases, last-intersection and its direction and phases, wave section instructions; parameters of each wave section instruction include: instructions of start or end; connections of straight phase wave, out-phase front wave or out-phase post wave; functions of Lead or Jam-Relief; road-sections of intersections and source intersection and their direction and phases, using coordinates or sequence numbers for them; Said wave section here means several road-segments connected in series running a specified connection and function traffic signals, straight phase or out-phase, Lead or Jam-Relief;

Said out-phase front wave and said out-phase post wave constitute a whole out-phase wave, with corresponding out-phase front wave section and out-phase post wave section; said out-phase front wave section consists of out-phase front intersection and its direction phases and out-phase intersection and its direction phases; said out-phase post wave section consists of out-phase intersection and its direction phases and out-phase post intersection and its direction phases; Said out-phase intersection means such an intersection that the intersection's turning-phase green light is connected with the other intersection's different phase green light of the road-segment of the both intersections; correspondingly, straight phase intersection is an intersection whose straight phase is involved in connection with the other intersection's signal phase of a road-segment, straight wave is that straight phase intersections consist of straight phase signals connection, that's a green wave; said out-phase front intersection is an upstream intersection in an out-phase wave road-segment; said out-phase post intersection is a downstream intersection in an out-phase wave road-segment; said out-phase wave road-segment means at least one intersection of a road-segment is an out-phase intersection.

Another feature of the method for polylines Lead and Jam-Relief mixture mode, is that at step S2 includes steps of: S21, Said parameters of polylines mixture wave include first-intersection and its direction and phases, last-intersection and its direction and phases, wave section instructions; parameters of each wave section instruction include: instructions of start or end; connections of straight phase wave, out-phase front wave or out-phase post wave; functions of Lead or Jam-Relief; road-sections of intersections and source intersection and their direction and phases, using coordinates or sequence numbers for them; Said wave section here means several road-segments connected in series running a specified connection and function traffic signals, straight phase or out-phase, Lead or Jam-Relief.

Another feature of the method for polylines Lead and Jam-Relief mixture mode, is that at step S2 includes steps of: S22.1, Said a signal start interim period of starting polylines mixture wave include:

(S22.1.1) according to parameters of polylines mixture wave of mode instruction, compute time-offsets of every wave section orderly from source intersection;

(S22.1.2) connecting the time-offsets of the wave sections;

(S22.1.3) make interim period using the time-offsets of the wave sections.

Another feature of the method for polylines Lead and Jam-Relief mixture mode, is that at step S2 includes steps of: S22.11, Said computation of wave section time-offsets include:

(S22.11.1) get instruction and parameters of wave section;

(S22.11.2) compute time-offsets: starting straight phase wave, starting out-phase front wave, starting out-phase post wave, or end;

For starting out-phase front wave, compute time-offsets using out-phase front drive time for function Lead, or, using out-phase front JVQ starting time for function Jam-Relief;

For starting out-phase post wave, compute time-offsets using out-phase post drive time for function Lead, or, using out-phase post JVQ starting time for function Jam-Relief;

Said out-phase front drive time means set drive time of the road-segment where an out-phase front wave runs, with additional lead time included, where the additional lead time is caused by vehicle's braking to an out-phase intersection;

Said out-phase front JVQ start time means JVQ start time of the road-segment where an out-phase front wave runs;

Said out-phase post drive time means set drive time of the road-segment where an out-phase post wave runs, with additional lead time included, where the additional lead time is caused by vehicle's braking to an out-phase intersection;

Said out-phase post JVQ start time means JVQ start time of the road-segment where an out-phase post wave runs, plus out-phase post additional time;

Another feature of the method for connecting out-phases' green signals between intersections, is that at step S2 includes steps of: S22.112.1, compute out-phase front wave time-offsets using front drive time for function Lead, or, using front JVQ start time for Jam-Relief;

Said front drive-time is set drive time of the road-segment where an out-phase front wave runs, with additional lead time included; Said out-phase front JVQ start time means JVQ start time of the road-segment where an out-phase front wave runs.

Another feature of the method for connecting out-phases' green signals between intersections, is that at step S2 includes steps of: S22.112.2, compute out-phase post wave time-offsets using post drive time for function Lead, or, using post JVQ start time for Jam-Relief;

Said post drive-time is set drive time of the road-segment where an out-phase post wave runs, with additional lead time included; Said out-phase post JVQ start time means JVQ start time of the road-segment where an out-phase post wave runs, plus out-phase post additional time.

Another feature of the method for connecting out-phases' green signals between intersections, is that at step S2 includes steps of: S22.112.3, compute start out-phase wave time-offsets with optimizing: adjust the intersections' phase times ratio, phase order of the road-segment of the out-phase wave, to minimize the time-offset.

Another feature of the method for polylines Lead and Jam-Relief mixture mode, is that at step S2 includes steps of: S22.112.4, Said out-phase wave optimizing include:

(S22.112.41) reconfigure phase time, ratio, and order of out-phase connected of out-phase intersection;

(S22.112.42) connecting phase time-offsets: phase time order time-offset that downstream intersection's connecting phase is compared with its upstream connected phase in phase time order;

(S22.112.43) common time-offset: connecting phase time-offsets−traffic time of the out-phase road-segment;

(S22.112.44) optimize the time-offset: if common time-offset<=0, then postpone the downstream intersection period by the common time-offset, or advance the upstream intersection period by the common time-offset, or, reconfigure phase time ratio according to the common time-offset; if common time-offset>0, then advance the downstream intersection period by the common time-offset, or postpone the upstream intersection period by the common time-offset, or, reconfigure phase time ratio according to the common time-offset;

Said traffic time uses front drive-time for out-phase front wave of function Lead, post drive-time for out-phase post wave of function Lead, front JVQ start time for out-phase front wave of function Jam-Relief, post JVQ start time for out-phase post wave of function Jam-Relief;

Said common time-offset=connecting phase time-offsets−traffic time of the out-phase road-segment;

Said connecting phase time-offsets=phase time order time-offset that downstream intersection's connecting phase is compared with its upstream connected phase in phase time order

=connecting phase green signal start time of downstream intersection−connected phase green signal start time of its upstream intersection.

Another feature of the method for polylines Lead and Jam-Relief mixture mode, is that at step S2 includes steps of:

S22.112.5, Said time-offset optimizing include: said connecting phase time-offsets=phase time order time-offset that downstream intersection's connecting phase is compared with its upstream connected phase in phase time order

=connecting phase green signal start time of downstream intersection−connected phase green signal start time of its upstream intersection.

Another feature of the method for polylines Lead and Jam-Relief mixture mode, is that at step S2 includes steps of: S22.112.6, Said time-offset optimizing include, Said common time-offset=connecting phase time-offsets−traffic time of the out-phase road-segment.

Another feature of the method for polylines Lead and Jam-Relief mixture mode, is that at step S2 includes steps of: S22.112.7, Said time-offset optimizing include: if common time-offset<=0, then postpone the downstream intersection period by the common time-offset, or advance the upstream intersection period by the common time-offset, or, reconfigure phase time ratio according to the common time-offset; if common time-offset>0, then advance the downstream intersection period by the common time-offset, or postpone the upstream intersection period by the common time-offset, or, reconfigure phase time ratio according to the common time-offset.

Another feature of the method for polylines Lead and Jam-Relief mixture mode, is that at step S2 includes steps of: S22.12.1, Said connecting the time-offsets of the wave sections include: elect the intersection that does not have phase-signal-connected upstream intersection but only has phase-signal-connecting downstream intersections as general source intersection of whole polylines mixture wave, with its time-offset=0, and its vehicle flow direction phase time as computing basic time of signal time sequence.

Another feature of the method for polylines Lead and Jam-Relief mixture mode, is that at step S2 includes steps of: S22.12.2, Said connecting the time-offsets of the wave sections include: add time-offsets, as phase-signal-connecting downstream intersection of its upstream wave section, of each source intersection of each wave section, to every intersection time-offset of corresponding wave section, orderly from the source intersection of the wave section that does not have phase-signal-connecting downstream wave section but only has phase-signal-connected upstream wave sections.

Another feature of the method for polylines Lead and Jam-Relief mixture mode, is that at step S2 includes steps of: S22.13.1, Said set out-phase start interim period include, from postponed time-offset, make the interim period by using period remainder of the time-offset, dividing the remainder into controlled phase signal times.

Another feature of the method for polylines Lead and Jam-Relief mixture mode, is that at step S2 includes steps of: S22.13.2, Said set out-phase start interim period include, from advanced time-offset of out-phases in same direction, make the interim period by dividing period complement of the advanced time-offset, into controlled phase signal times set.

Another feature of the method for polylines Lead and Jam-Relief mixture mode, is that at step S2 includes steps of: S22.13.3, Said set out-phase start interim period include, from advanced time-offset of out-phases in different directions, make the interim period by using period complement of the advanced time-offset.

Another feature of the method for polylines Lead and Jam-Relief mixture mode, is that at step S2 includes steps of: S22.13.4, Said set out-phase start interim period include, for advanced time-offset, by shortening the front portion of the period by the advanced time-offset, obtain the remaining time, shrink all phases before connecting phase into the remaining time.

Another feature of the method for polylines Lead and Jam-Relief mixture mode, is that at step S2 includes steps of: S22.13.5, Said set out-phase end interim period, for the advanced interim period, make the end interim period postponed by period complement of the advanced interim period.

Another feature of the method for polylines Lead and Jam-Relief mixture mode, is that at step S2 includes steps of: S22.13.6, Said set out-phase end interim period, make interim period using period complement of the current out-phase wave postponed time-offset.

Another feature of the method for polylines Lead and Jam-Relief mixture mode, is that at step S2 includes steps of:

S3, Run the new mode after running out the respective interim period of every intersection.

The advantages of the present invention are below: providing for polylines route traffic signal connecting channel, linking functions Lead and Jam-Relief within multi wave sections, multi road-segments, multi turnings of vehicle flow; comparing to current non-the-polylines-mixture-mode traffic signal modes, waiting time is lessened by far more than 50%, efficiency of transportation is improved greatly.

### BRIEF DESCRIPTION OF THE DRAWINGS

FIG. 1 is a general view of a polylines mixture wave;

FIG. 2 is structure of a road-net with traffic signal control system and polylines mixture wave time-offsets setting and running;

FIG. 3 is a flowchart of polylines mixture wave control method;

FIG. 4 shows an embodiment of polylines mixture interim period setting and running phase order with mixture of 5 wave sections, 2 turns, Lead and Jam-Relief functions;

### LIST OF REFERENCE NUMERAL UTILIZED IN THE DRAWING

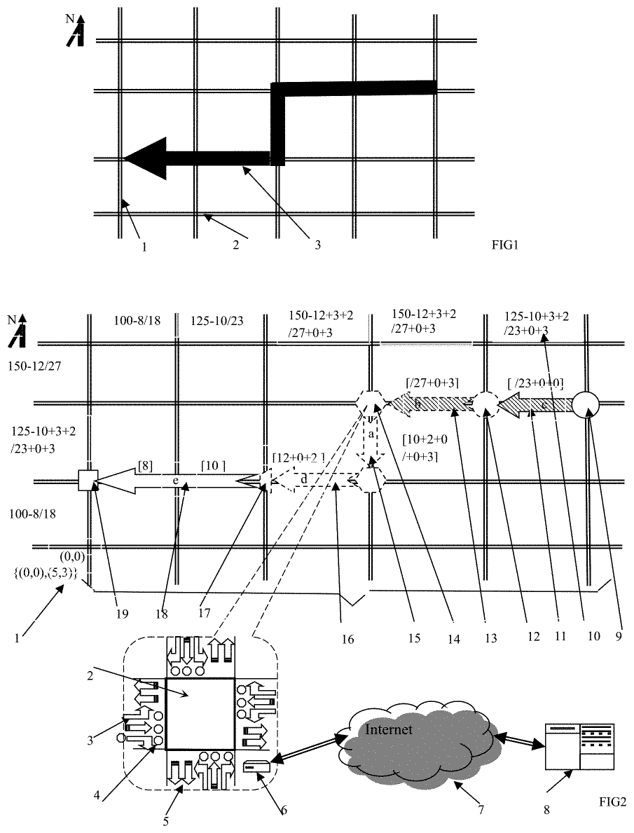

FIG. 1: 1—road-net, 2—intersection, 3—Multi road-segments, multi turns mixture wave;

FIG. 2: 1—at lower-left corner, origin intersection's coordinates (0,0) of a road-net; wherein {(0,0),(5,3)} marked for the road-net; 2—intersection; 3—vehicle queue waiting for pass, including straight, left, right 3 phases vehicle queues; 4—traffic signals, including straight, left, right 3 phases signals; 5—vehicle queue passed; 6—traffic signals controller; 7—internet; 8—control system center; 9—start (first) intersection (5,2) of a polylines mixture wave, labeled a circle; 10— intersection spacing−set-drive-time/JVQ start time, denoted as “#−#/#”: unit, second for set-drive-time, set drive speed of 45 km/h, second for JVQ start-time, (JVQ start-time equals to JVQ-start-coefficient*jam-coefficient*road-segment-length), wherein the JVQ-start-coefficients are empirical values of JVQ start, in range of 0.14 to 0.22, taking middle value 0.18 usually, assuming that heavy jam is in road-segment, i.e. jam-coefficicient=1, vehicle queue length reaches road-segment length, apart-coefficient=1, omitting widths of intersections, thus, JVQ start-time=road-segment length*0.18, other labels of “#−#+#+#/#−#+#+#”, 4 numbers # led by “+” are separately Lead out-phase front additional time and Lead out-phase post additional time, Jam-Relief out-phase front additional time and Jam-Relief out-phase post additional time; 11—row road-segment (2,4), in wave section 1, straight phase wave, Jam-Relief function, arrow oblique line pointing to left-west, labeled of c, wherein [#+#+0/#+0+#] are for [drive time+Lead out-phase front additional time+Lead out-phase post additional time/JVQ start time+Jam-Relief out-phase front additional time+Jam-Relief out-phase post additional time] of the road-segment in the wave section; 12—out-phase start intersection (4,2), also called as out-phase front intersection, start intersection of wave section, denoted by dotted line circle; 13—row road-segment (2,3), in wave section 2, out-phase front wave, Jam-Relief function, arrow line pointing left-west, labeled by b; 14—out-phase intersection (3,2), denoted as dotted line hexagon; 15—column road-segment (3,1), in wave section 3, out-phase post wave, Lead function, arrow hollow dotted line pointing down-south, labeled by a, wherein [10+2+0/+0+3] are for [this road-segment: drive time 10+out-phase front additional time 0+Lead out-phase post additional time 0]/[upstream road-segment: JVQ start time 0+Jam-Relief out-phase front additional time 0+Jam-Relief out-phase post additional time 3]; 16—row road-segment (1,2), in wave section 4, out-phase post wave, Lead function, arrow hollow dotted line pointing to left-west, labeled by d; 17—out-phase post intersection (2,1), denoted by trapezoid; 18—row road-segment (1,1) to (1,0), in wave section 5, straight phase wave, Lead function, arrow hollow dotted line pointing to left-west, labeled by e; 19—out-phase end intersection (0,1), also end intersection of wave section, denoted by rectangle;

### DETAILED DESCRIPTION OF THE INVENTION

### Description of The Preferred Embodiment, Industry Applications

A detailed description of embodiment of the invention in conjunction with the accompanying drawings:

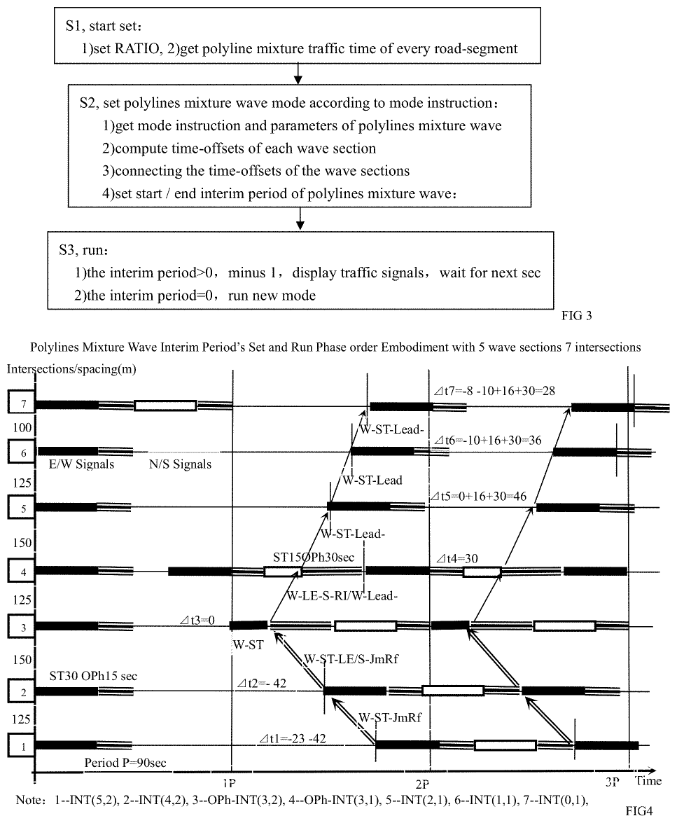

Create road-net system as shown in FIG. 2, intersection as label 2-2, vehicle flow as labels 2-3,2-5 of intersections, are equipped with straight/left/right three phases signals as label 2-4, with a traffic signal machine as label 2-6 or with sensors, controlled through the communication network as label 2-7 by the control center as label 2-8 which execute the polylines mixture wave mode control methods and flowchart as shown in FIG. 3;

In FIG. 2, features of a road-net include: coordinates(0,0) as label 2-1 of origin intersection at the lower left corner of road-net {(0,0), (5,3)} or {6,4}, which has a total of 24 intersections, 6 North-South col.-D-channels and 4 East-West row-D-channels, the set of the traffic-time of the col-D-channels Col. {6,3} {==}, for 18 corresponding North-South road-segments, the set of the traffic-time of the row-D-channels Row{5,4} {==}, for 20 corresponding East-West road-segments of the row-D-channels; the “#−#/#” as label 2-10 for length #−its set-drive-time # of each road-segment, unit: meter—second, wherein set-drive-time is calculated based on set-drive-speed=45 kilometers/hour, for an example, the length of row road-segment (2,3) between intersection (4,2) and intersection (3,2) is 150 meters, its set-drive-time 12 secs, the length of column road-segment (2,2) between intersection (2,2) and intersection (2,1) is 125 meters, its JVQ start-time is 23 secs;

In FIG. 2, said polylines mixture wave control method, include steps of,

S1, (1) Set RATIO as initial state for every intersection of a road-net, period=90 sec, direction phases time ratio=1, each direction phase time=45 sec., straight-turn (left/right) phases time ratio=2, straight phase time=30 sec., turn (left/right) phases time=15 sec., phase order: straight first then turn (out-phase); (2) obtain the length and traffic-time, including out-phase traffic time, as label 2-13, 2-15, of every road-segment of the road-net of 6*4 intersections, 6 columns of channels, 4 rows of channels;

S2, Set polylines mixture wave interim period according to mode instruction:

1) get parameters of polylines mixture wave of the mode instruction; as below table1,

Start intersection (5,2)-vehicle flow direction west straight phase, end intersection (0,1)-vehicle flow direction west straight phase, instructing 5 wave section;

TABLE 1

| Wave | Instruct - | | Road-segment | Source INT - | Dnstream INT - |
|---|---|---|---|---|---|
| section# | function | connection | controlled | DIR/phase | DIR/phase |
| 1 | start- | ST wave | row (2, 4) | INT (4, 2) - W/ST | INT (5, 2) - W/ST |
| | JmRf | | | | |
| 2 | Start- | 0 Ph front wave | row (2, 3) | INT (3, 2) - W/LT | INT (4, 2) - W/ST |
| | JmRf | | | | |
| 3 | Start- | 0 Ph post wave/ | col (3, 1) | INT (3, 2) - W/LT | INT (3, 1) - S/RT |
| | Lead | 0 Ph front wave | | | |
| 4 | Start- | 0 Ph post wave | row(1, 2) | INT (3, 1) - S/RT | INT (2, 1) - W/ST |
| | Lead | | | | |
| 5 | Start- | ST wave | row (1, 1) | INT (2, 1) - W/ST | INT (1, 1) - W/ST |
| | Lead | | row (1, 0) | | INT (0, 1) - W/ST |

said INT(4,2)-W/ST, wherein W is for west direction of vehicle flow direction of intersection (4,2), ST is for straight phase; and, LT is for left turn phase, RT is for right turn phase, S for South direction, Dnstream for downstream, DIR for direction;
said wave section 3 plays double roles: OPh front/post wave, means that out-phase post wave of out-phase intersection (3,2) and out-phase front wave of out-phase intersection (3,1); OPh is for out-phase, JmRf is for Jam-Relief;
2) set the polylines mixture wave start interim period:

(S22.1) according to parameters of polylines mixture wave of mode instruction, compute time-offsets of every wave section orderly from their self source intersection;

(S22.11) get instruction and parameters of wave section: instruction, function, connection, road-segments and intersection of each wave section, as table 1;

(S22.12) compute time-offsets: start straight phase wave, start out-phase front wave, start out-phase post wave, or, end:
a. compute traffic times of road-segments in each wave section, as in table 2, its column 4 “drive time/JVQ start time”, before “/” is drive time, after “/” is JVQ start time, and “+#+#” led by “+” are “lead front additional time”+“lead post additional time”, for an example, wave section 2's “/27 sec+0+3” denoted for JVQ start time start time 27 sec, JVQ front additional time 0 sec, JVQ post additional time 3 sec, which results in time-offset 27 sec postponed;

TABLE 2

| | | | | | Wave section | Dnstream |
|---|---|---|---|---|---|---|
| Wave | Reset phase | Connecting | Drive time/JVQ | Common time- | Source INT// | INT//time- |
| section# | time ratio | phases time-offsets//value | start time | offset | time-offset | offset |
| 1 | no | W/ST − W/ST//0 | /23 [symbol] = −23 | 0 − 23 = −23 | INT (4, 2)//0 | INT (5, 2)//−23 |
| 2 | INT (3, 2)-W/LT30 | W/ST − W/LT// | /27 [symbol] + 0 + 3 = −27 | −15 − 27 = −42 | INT (3, 2)//0 | INT (4, 2)//−42 |
| | share | 0 − 15 = −15 | | | share source | |
| 3 | INT (3, 1)-S/RT30 | S/RT − W/LT// | 10 [symbol] + 3 + 0/+0 + 2 = −15 | 45 − 15 = 30 | INT (3, 2)//0 | INT (3, 1)//30 |
| | share | 60 − 15 = 45 | | | share source | |
| 4 | INT (3, 1)-S/RT30 | W/ST − S/RT// | 12 [symbol] + 0 + 2/=−14 | 30 − 14 = 16 | INT (3, 1)//0 | INT (2, 1)//16 |
| | | 90 − 60 = 30 | | | | |
| 5 | no | W/ST − W/ST//0 | 10 [symbol] /=−10 | 0 − 10 = −10 | INT (2, 1)//0 | INT (1, 1)//−10 |
| | no | | 8 [symbol] /=−8 | −10 − 8 = −8 | | INT (0, 1)//−18 |

Note(1):
“−” in −15 is for downstream connecting phase time 15 sec earlier than upstream connected phase time, needing postponed,
Note(2):
positive 45 is for downstream connecting phase time 15 sec later than upstream connected phase time,
Note(3):
negative common time-offset means downstream connecting phase time needing postponed, its positive means downstream connecting phase time needing advanced, or, for the negative, make its upstream connected phase time advanced by the common time-offset, for its positive, make its upstream connected phase time postponed by the common time-offset;
Said downstream or upstream are all based on green wave signal propagating direction, Lead green wave direction follow direction of vehicle flow, Jam-Relief green wave reverse to direction of vehicle flow;
b. optimize, as table 2's column 2 “reset phase time ratio”, for an example, wave section 2's intersection INT(3, 2)'s west vehicle flow W's left phase LT time is reset as 30 sec, straight phase ST time reset as 15 sec;
c. compute the optimized time-offset of each wave section, as table 2's columns 3, 5, 6, 7,
Column 3 “connecting phases time-offsets”, for an example, in wave section 2, “W/ST − W/LT” means that the time-offset between downstream west vehicle flow's phase LT and upstream west phase ST is, 0 − 15 = −15, wherein “//” leads the related values;
Column 5 “common time-offsets”, for an example, in wave section 2, equals “connecting phase time-offsets − traffic time”, −15 − 27 = −42,
Column 6 “wave section source INT//time-offsets”, for an example, in wave section 2, is intersection “INT(3, 2)”, its time-offset is 0,
Column 7 “downstream INT//time-offsets”, for an example, in wave section 2, is intersection “INT(4, 2)”, its time-offset 42 sec is postponed;

(S22.2) connecting wave sections' time-offsets:

(S22.21) elect the intersection that does not have phase-signal-connected upstream intersection but only has phase-signal-connecting downstream intersections as general source intersection of whole polylines mixture wave, with its time-offset=0, and its vehicle flow direction phase time as computing basic time of signal time sequence, for an example, INT(3,2) in column 6 of table 2;

(S22.22) add time-offsets, as phase-signal-connecting downstream intersection of its upstream wave section, of each source intersection of each wave section, to every intersection time-offset of corresponding wave section, orderly from the source intersection of the wave section that does not have phase-signal-connecting downstream wave section but only has phase-signal-connected upstream wave sections, obtain connecting time-offset of every intersection, as column 4 “connecting time-offset//values” of every INT of table 3 below;

TABLE 3

| | Wave section | Downstream | | INT interim |
|---|---|---|---|---|
| Wave | source INT// | INT//time- | Connecting time- | period//moveto, shunt |
| section# | time-offset | offset | offset//values | phase values |
| 1 | INT (4, 2)//0 | INT (5, 2)//−23 | INT (5, 2)//−23 − 42 = −65 | postponed, 65 = 33 + 32, |
| | | | | 33 = 20 + 13, 32 = 20 + 12 |
| 2 | INT (3, 2)//0 | INT (4, 2)//−42 | INT (4, 2)//−42 | postponed, 42 = 22 + 20, |
| | Share source | | | 22 = 14 + 8, 20 = 13 + 7 |
| | | | INT (3, 2)//0 | 0 |
| | | | Share source | |
| 3 | INT (3, 2)//0 | INT (3, 1)//30 | INT (3, 1)//30 | advanced, 90 − 30 = 15 + 45, |
| | Share source | | | 15 = W/0 Ph, 45 = 15 + 30/0 Ph |
| 4 | INT (3, 1)//0 | INT (1, 1)//16 | INT(1, 1)//16 + 30 = 46 | advanced, 90 − 46 = 22 + 22, |
| | | | | 22 = 14 + 8, 22 = 14 + 8 |
| 5 | INT (2, 1)//0 | INT (1, 1)//−10 | INT (1, 1)//−10 + 46 = 36 | advanced, 90 − 36 = 27 + 27, |
| | | | | 27 = 18 + 9, 27 = 18 + 9 |
| | | INT (0, 1)//−18 | INT (0, 1)//−18 + 46 = 28 | advanced, 90 − 28 = 31 + 31, |
| | | | | 31 = 20 + 11, 31 = 20 + 11 |

make the interim period with the optimized time-offsets of every wave section; make postponed interim period: Wave section 1, wave section 2: divide their self optimized time-offset as phases time sum into phases times of shrinked period; make advanced interim period: for wave section 3, wave section 4, wave section 5, 90 − advanced time-offset = advanced interim period, wave section 4, wave section 5 in same direction out-phases connection: divide their self optimized time-offset as phases time sum into phases times of shrinked period, wave section 3 in different direction out-phase, direction west with phase LT connecting south with RT, decrease the front part of its period by its interim period with shrinking all phases time of the front part into the remaining part; S3, Run the new mode after running out out-phase interim period traffic signals of every intersection: interim period > 0, display traffic signals, wait next second, until the interim period = 0, run new mode;

FIG. 4 shows 4 the above described embodiment of a polylines mixture wave time set and running time sequence, a signal polylines mixture wave channel of 7 intersections INTs of 6 road-segments in 5 wave sections with 2 turns and mixture of Lead and Jam-Relief, vertical axis is for 7 out-phase signal connecting intersections and their spacing, square and INT are for intersections, including intersection INT(0,1), intersection INT(1,1), intersection INT(2,1), intersection INT(3,1), intersection INT(3,2), intersection INT(4,2), intersection INT(5,2), their spacing are orderly E-W100 meters, E-W125 m, E-W150 m, N-S125 m, E-W150 m, E-W125 m; horizontal axis is for time, labels of 1P, 2P, 3P are 3 signal period scales of 90 seconds, above the horizontal axis there are combined lines of thick solid lines and triple lines stand for West-East signal phase time and phase shunt (i.e.,turn) structure, the ratio of straight-turn shunt phase times is 2 to 1, thick solid lines is for straight phase time 30 sec., triple lines for turn left/right phase time 15 sec.; the time spaces of two West-East signal phase time are North-South signal phase time; combined lines of thick hollow solid lines and triple lines stand for North-South signal phase time and phase shunt (i.e.,turn) structure, the ratio of straight-turn shunt phase times is 2 to 1, thick hollow solid lines is for straight phase time 30 sec., triple lines for turn left/right phase time 15 sec.; arrow oblique solid lines pointing up-right are for vehicle flow directions led by Lead, and shows that during the time spacing on the time axis that vehicles flow through intersection spacing distance arrives at the intersection and the phase time pointed; arrow oblique hollow lines pointing up-left are for vehicle flow directions relieved by Jam-Relief, and shows that during the time spacing on the time axis at time instant when a vehicle of JVQ start to move at position at where the vehicle of the JVQ is within the spacing, which show in projection or interception separately on the vertical and horizontal axis of each point on the oblique line;

the above time-offset setting and running:

Wave section 1, Jam-Relief time-offset of this road-segment of −23 sec, plus the time-offset sum of its upstream wave sections of −42 sec, is −65=−23−42 sec, intersection (5,2)'s period is postponed by Δ t1=−65, that's, after the signal wave upstream intersection (4,2)'s straight phase turns on green light for 23 sec, intersection (5,2) turns on straight phase green light, letting west-going vehicles enter the space vacated just now from JVQ; Wave section 2, Jam-Relief time-offset of this out-phase front wave of −42 sec, intersection (4,2)'s period postponed by Δ t2=−42 sec, which enables that with reset left phase time as 30 sec after intersection (3,2)'s left phase turns on green light for 42 sec, intersection (4,2) turns on straight phase green light, letting west-going vehicles enter the space vacated just now from JVQ;

Wave section 3, Jam-Relief/Lead time-offset of this out-phase Jam-Relief post wave and out-phase Lead front wave of 30=30+15−15 sec, including out-phase Jam-Relief post wave additional time 2 sec and out-phase front wave additional time 3 sec, downstream intersection (3,1)'s period advanced by 30 sec, Δ t4=30 sec, intersection (3,2)'s period time-offset Δ t3=0, which enables that with reset left phase time as 30 sec after this intersection's left phase turns on green light for 15 sec, intersection (3,1) with reset right phase time as 30 sec turns on right phase green light, letting south-going and right-turning vehicles just arriving to pass;

Wave section 4, Lead time-offset of this out-phase post wave of 46=16+30 sec, intersection (2,1)'s period advanced by Δ t5=46 sec, that's, which enables that with reset right phase time as 30 sec after intersection (3,1)'s left phase turns on green light for 15 sec, intersection (2,1) turns on straight phase green light, letting west-going vehicles just arriving to pass;

Wave section 5, Lead time-offset of this out-phase wave, through 3 intersections, their source intersection (2,1) Δ t5=46 sec, intersection (1,1), end intersection (0,1), downstream intersections' time-offsets Δ t6=−10+46=36 sec advanced, Δ t7=−18+46=28 sec advanced, that's, after the source intersection (2,1)'s straight phase turns on green light for 10 sec, intersection (1,1) turns on straight phase green light, and then after 18 sec, intersection (0,1) turns on straight phase green light, letting west-going vehicles just arriving to pass.

What is claimed as new and desired to be protected by Letters Patent is set forth in the following:

1. A method for polylines Lead and Jam-Relief mixture mode in traffic signal network includes steps:
S1, Set RATIO as initial state with obtaining length and traffic time of every road-segment of a road-net;
S2, Set polylines mixture wave mode according to mode instruction: 1) get parameters of polylines mixture wave of the mode instruction; 2) set a signal interim period of the polylines mixture wave: start polylines mixture wave, or, end;
S3, Run the new mode after running out the respective interim period of every intersection;
Said road-net is a group of mutually crossing roads, wherein its crossing points with their every directions controlled with traffic signals, called as intersections, divide the roads into road-segments, parallelly topologically;
Said RATIO is a traffic signal mode of road-nets, wherein all intersections' traffic signals run on ratio-rule synchronously, said ratio-rule bases on a period and ratios dividing the period into traffic signals controlling directions, said period is traffic signal green light times' sum of every directions controlled of an intersection;
Said polylines mixture wave means traffic signal phase green lights of road-segments connected include not only mixture of straight phase wave and out-phase wave of left-turn phase and right-turn phase but also mixture of functions of Jam-Relief and Lead; Said out-phase wave means traffic signal phase green lights connected between intersections include turning phases of left-turn phase and right-turn phase, is an out-phase mode of green-wave; Said green-wave ordinarily means that traffic signal green lights' phases connected between intersections only are straight phase based on said ratio-rule and time-offsets, runs on said ratio-rule asynchronously, and orderly time-offsets make green light signal propagate between intersections directionally, from a source intersection to the intersection's adjacent one with bigger time-offset; Said source-intersection is an intersection of a green-wave set smallest time-offset comparing with the other intersections in the green-wave road-net;
Said interim period is sum of traffic signal green light interim times in all directions controlled, is period remainder of switch time-offset of new mode comparing with current mode, in which traffic signal mode of an intersection changes from current mode to new mode; Said switch-time-offset is time-offset of two modes of new mode comparing with current mode, equals sum of current mode's complement and new mode's remainder; Said remainder is period remainder, =remainder (time-offset/period); Said complement is period complement, =period−remainder; Said time-off is a delay of an intersection period comparing with a mode source intersection period, related to cared distance and traffic time, is sum of all related road-segments time-offsets from source intersection to a downstream intersection of a green-wave;
Said traffic-time includes set-drive-time or JVQ-start-time; said set-drive-time equals to time that a vehicle drives at set-drive-speed through a whole road-segment; said JVQ means jammed vehicle queue, its length as a parameter of Jam-Relief green-wave is the length of a road-segment it is in; said JVQ-start-time is a basic parameter of Ram-Relief green-wave, means time from when the first vehicle of JVQ start to move to when last vehicle of JVQ start to move, equals to JVQ-start-coefficient*jam-coefficient*road-segment-length; said JVQ-start-coefficient are empirical values of JVQ start, in range of 0.10 to 0.26, taking middle value 0.18 usually, unit: second/meter, also may be obtained from certain functions or statistical principle dynamically; said jam-coefficient is less than or equal to one, “equals to one” means that heavy jam occurs;
Said parameters of polylines mixture wave include first-intersection and its direction and phases, last-intersection and its direction and phases, wave section instructions; parameters of each wave section instruction include: instructions of start or end; connections of straight phase wave, out-phase front wave or out-phase post wave; functions of Lead or Jam-Relief; road-sections of intersections and source intersection and their direction and phases, using coordinates or sequence numbers for them; Said wave section here means several road-segments connected in series running a specified connection and function traffic signals, straight phase or out-phase, Lead or Jam-Relief;
Said out-phase front wave and said out-phase post wave constitute a whole out-phase wave, with corresponding out-phase front wave section and out-phase post wave section; said out-phase front wave section consists of out-phase front intersection and its direction phases and out-phase intersection and its direction phases; said out-phase post wave section consists of out-phase intersection and its direction phases and out-phase post intersection and its direction phases; Said out-phase intersection means such an intersection that the intersection's turning-phase green light is connected with the other intersection's different phase green light of the road-segment of the both intersections; correspondingly, straight phase intersection is an intersection whose straight phase is involved in connection with the other intersection's signal phase of a road-segment, straight wave is that straight phase intersections consist of straight phase signals connection, that's a green wave; said out-phase front intersection is an upstream intersection in an out-phase wave road-segment; said out-phase post intersection is a downstream intersection in an out-phase wave road-segment; said out-phase wave road-segment means at least one intersection of a road-segment is an out-phase intersection.

2. A method for polylines Lead and Jam-Relief mixture mode as in claim 1, wherein step S2 includes: S21, Said parameters of polylines mixture wave include first-intersection and its direction and phases, last-intersection and its direction and phases, wave section instructions; parameters of each wave section instruction include: instructions of start or end; connections of straight phase wave, out-phase front wave or out-phase post wave; functions of Lead or Jam-Relief; road-sections of intersections and source intersection and their direction and phases, using coordinates or sequence numbers for them; Said wave section here means several road-segments connected in series running a specified connection and function traffic signals, straight phase or out-phase, Lead or Jam-Relief.

3. A method for polylines Lead and Jam-Relief mixture mode as in claim 1, wherein step S2 includes: S22.1, Said a signal start interim period of starting polylines mixture wave include:
(S22.1.1) according to parameters of polylines mixture wave of mode instruction, compute time-offsets of every wave section orderly from source intersection;
(S22.1.2) connecting the time-offsets of the wave sections;
(522.1.3) make interim period using the time-offsets of the wave sections.

4. A method for polylines Lead and Jam-Relief mixture mode as in claim 1, wherein step S2 includes: S22.11, Said computation of wave section time-offsets include:
(S22.11.1) get instruction and parameters of wave section;
(522.11.2) compute time-offsets: starting straight phase wave, starting out-phase front wave, starting out-phase post wave, or end;
For starting out-phase front wave, compute time-offsets using out-phase front drive time for function Lead, or, using out-phase front JVQ starting time for function Jam-Relief;
For starting out-phase post wave, compute time-offsets using out-phase post drive time for function Lead, or, using out-phase post JVQ starting time for function Jam-Relief;
Said out-phase front drive time means set drive time of the road-segment where an out-phase front wave runs, with additional lead time included, where the additional lead time is caused by vehicle's braking to an out-phase intersection;
Said out-phase front JVQ start time means JVQ start time of the road-segment where an out-phase front wave runs;
Said out-phase post drive time means set drive time of the road-segment where an out-phase post wave runs, with additional lead time included, where the additional lead time is caused by vehicle's braking to an out-phase intersection;
Said out-phase post JVQ start time means JVQ start time of the road-segment where an out-phase post wave runs, plus out-phase post additional time.

5. A method for polylines Lead and Jam-Relief mixture mode as in claim 1, wherein step S2 includes: S22.112.1, compute out-phase front wave time-offsets using front drive time for function Lead, or, using front JVQ start time for Jam-Relief;
Said front drive-time is set drive time of the road-segment where an out-phase front wave runs, with additional lead time included; Said out-phase front JVQ start time means JVQ start time of the road-segment where an out-phase front wave runs.

6. A method for polylines Lead and Jam-Relief mixture mode as in claim 1, wherein step S2 includes: S22.112.2, compute out-phase post wave time-offsets using post drive time for function Lead, or, using post JVQ start time for Jam-Relief;
Said post drive-time is set drive time of the road-segment where an out-phase post wave runs, with additional lead time included; Said out-phase post JVQ start time means JVQ start time of the road-segment where an out-phase post wave runs, plus out-phase post additional time.

7. A method for polylines Lead and Jam-Relief mixture mode as in claim 1, wherein step S2 includes: S22.112.3, compute start out-phase wave time-offsets with optimizing: adjust the intersections' phase times ratio, phase order of the road-segment of the out-phase wave, to minimize the time-offset.

8. A method for polylines Lead and Jam-Relief mixture mode as in claim 1, wherein step S2 includes: S22.112.4, Said out-phase wave optimizing include:
(S22.112.41) reconfigure phase time, ratio, and order of out-phase connected of out-phase intersection;
(S22.112.42) connecting phase time-offsets: phase time order time-offset that downstream intersection's connecting phase is compared with its upstream connected phase in phase time order;
(S22.112.43) common time-offset: connecting phase time-offsets−traffic time of the out-phase road-segment;
(S22.112.44) optimize the time-offset: if common time-offset<=0, then postpone the downstream intersection period by the common time-offset, or advance the upstream intersection period by the common time-offset, or, reconfigure phase time ratio according to the common time-offset; if common time-offset>0, then advance the downstream intersection period by the common time-offset, or postpone the upstream intersection period by the common time-offset, or, reconfigure phase time ratio according to the common time-offset;
Said traffic time uses front drive-time for out-phase front wave of function Lead, post drive-time for out-phase post wave of function Lead, front JVQ start time for out-phase front wave of function Jam-Relief, post JVQ start time for out-phase post wave of function Jam-Relief;
Said common time-offset=connecting phase time-offsets−traffic time of the out-phase road-segment;
Said connecting phase time-offsets=phase time order time-offset that downstream intersection's connecting phase is compared with its upstream connected phase in phase time order=connecting phase green signal start time of downstream intersection−connected phase green signal start time of its upstream intersection.

9. A method for polylines Lead and Jam-Relief mixture mode as in claim 1, wherein step S2 includes: S22.112.5, Said time-offset optimizing include: said connecting phase time-offsets=phase time order time-offset that downstream intersection's connecting phase is compared with its upstream connected phase in phase time order
=connecting phase green signal start time of downstream intersection−connected phase green signal start time of its upstream intersection.

10. A method for polylines Lead and Jam-Relief mixture mode as in claim 1, wherein step S2 includes: S22.112.6, Said time-offset optimizing include, Said common time-offset=connecting phase time-offsets−traffic time of the out-phase road-segment.

11. A method for polylines Lead and Jam-Relief mixture mode as in claim 1, wherein step S2 includes: S22.112.7, Said time-offset optimizing include: if common time-offset<=0, then postpone the downstream intersection period by the common time-offset, or advance the upstream intersection period by the common time-offset, or, reconfigure phase time ratio according to the common time-offset; if common time-offset>0, then advance the downstream intersection period by the common time-offset, or postpone the upstream intersection period by the common time-offset, or, reconfigure phase time ratio according to the common time-offset.

12. A method for polylines Lead and Jam-Relief mixture mode as in claim 1, wherein step S2 includes: S22.12.1, Said connecting the time-offsets of the wave sections include: elect the intersection that does not have phase-signal-connected upstream intersection but only has phase-signal-connecting downstream intersections as general source intersection of whole polylines mixture wave, with its time-offset=0, and its vehicle flow direction phase time as computing basic time of signal time sequence.

13. A method for polylines Lead and Jam-Relief mixture mode as in claim 1, wherein step S2 includes: S22.12.2, Said connecting the time-offsets of the wave sections include: add time-offsets, as phase-signal-connecting downstream intersection of its upstream wave section, of each source intersection of each wave section, to every intersection time-offset of corresponding wave section, orderly from the source intersection of the wave section that does not have phase-signal-connecting downstream wave section but only has phase-signal-connected upstream wave sections.

14. A method for polylines Lead and Jam-Relief mixture mode as in claim 1, wherein step S2 includes: S22.13.1, Said set out-phase start interim period include, from postponed time-offset, make the interim period by using period remainder of the time-offset, dividing the remainder into controlled phase signal times.

15. A method for polylines Lead and Jam-Relief mixture mode as in claim 1, wherein step S2 includes: S22.13.2, Said set out-phase start interim period include, from advanced time-offset of out-phases in same direction, make the interim period by dividing period complement of the advanced time-offset, into controlled phase signal times set.

16. A method for polylines Lead and Jam-Relief mixture mode as in claim 1, wherein step S2 includes: S22.13.3, Said set out-phase start interim period include, for advanced time-offset, make the interim period by using period complement of the advanced time-offset.

17. A method for polylines Lead and Jam-Relief mixture mode as in claim 1, wherein step S2 includes: S22.13.4, Said set out-phase start interim period include, for advanced time-offset, by shortening the front portion of the period by the advanced time-offset, obtain the remaining time, shrink all phases before connecting phase into the remaining time.

18. A method for polylines Lead and Jam-Relief mixture mode as in claim 1, wherein step S2 includes: S22.13.5, Said set out-phase end interim period, for the advanced interim period, make the end interim period postponed by period complement of the advanced interim period.

19. A method for polylines Lead and Jam-Relief mixture mode as in claim 1, wherein step S2 includes: S22.13.6, Said set out-phase end interim period, make interim period using period complement of the current out-phase wave postponed time-offset.

20. A method for polylines Lead and Jam-Relief mixture mode as in claim 1, wherein includes: S3, Run the new mode after running out the respective interim period of every intersection.
